(19) United States
(12) Patent Application Publication
(10) Pub. No.: US 2007/0250852 A1
(43) Pub. Date: Oct. 25, 2007

(54) System and method of editing video content

(75) Inventors: Thomas Hinman Adams, San Antonio, TX (US); Steven Michael Wollmershauser, San Antonio, TX (US); Brian Wilson, San Antonio, TX (US); Yolius Diroo, San Antonio, TX (US); William R. Hurst, San Antonio, TX (US)

Correspondence Address: TOLER SCHAFFER, LLP, 8500 BLUFFSTONE COVE, SUITE A201, AUSTIN, TX, 78759, US

(73) Assignee: SBC Knowledge Ventures, LP, Reno, NV (US)

(21) Appl. No.: 11/387,535

(22) Filed: Mar. 23, 2006

(51) Int. Cl. H04N 7/173; H04N 7/16

(52) U.S. Cl. 725/28; 725/135; 725/105

(57) ABSTRACT

A system and method of editing video content is disclosed. In a particular embodiment, the method includes receiving a command at a set-top box device, wherein the command includes a request to edit at least one objectionable audio portion associated with video content. The method also includes receiving the video content at the set-top box device, wherein the video content includes a closed-caption component. The method also includes determining whether the closed-caption component of the video content includes text related to the at least one objectionable audio portion.

### FIELD OF THE DISCLOSURE

The present disclosure is generally related to editing video content.

### BACKGROUND

Television service providers offer viewers a variety of movie and television programming. Not all video content offered by providers is appropriate for all viewers. Users often wish to prevent certain viewers from watching certain video portions or hearing certain audio portions of a video program. Service providers have developed hardware and software, such as the V-chip, that prevents video content having certain ratings from being displayed at a display device.

In some cases, only a discrete portion of a video program may contain objectionable audio or video portions. Users may not object to sensitive viewers watching the remainder of the video program. Nonetheless, mechanisms for controlling the display of objectionable video content often prevent the entire program from being displayed, if the objectionable portions have led to an overall rating that is not permitted. Additionally, these mechanisms may not be applicable to video content from a digital video disc (DVD) player or video cassette recorder (VCR). Hence, there is a need for an improved system and method of editing video content.

### BRIEF DESCRIPTION OF THE DRAWINGS

FIG. 1 is a block diagram illustrating a particular embodiment of an Internet Protocol Television (IPTV) system;

FIG. 2 is a block diagram illustrating a particular embodiment of a system to edit video content;

FIG. 3 is a flow diagram illustrating a particular embodiment of a method of editing video content;

FIG. 4 is a flow diagram illustrating a second particular embodiment of a method of editing video content;

FIG. 5 is a flow diagram illustrating a particular embodiment of a method of providing editable video content;

FIG. 6 is a diagram illustrating a particular embodiment of a graphical user interface (GUI) to edit video content; and

FIG. 7 is a diagram of an illustrative embodiment of a general computer system.

### DETAILED DESCRIPTION OF THE DRAWINGS

A system to edit video content is disclosed and includes a processor and a memory device accessible to the processor. The memory device includes an editing module executable by the processor to determine whether a closed-caption component of video content includes text related to at least one objectionable audio portion. The editing module is executable by the processor to not include the at least one objectionable audio portion in connection with the video content at a display device coupled to the set-top box device.

In another embodiment, a method of editing video content is disclosed and includes receiving a command at a set-top box device, where the command includes a request to edit at least one objectionable audio portion associated with video content. The method also includes receiving the video content at the set-top box device, where the video content includes a closed-caption component. The method also includes determining whether the closed-caption component of the video content includes text related to the at least one objectionable audio portion.

In another embodiment, a method of editing video content is disclosed and includes receiving a request for video content from a set-top box device at a server of an Internet Protocol Television (IPTV) system. The method also includes transmitting a plurality of data packets of the video content to the set-top box device, where the plurality of data packets are received at a buffer of the set-top box device. The plurality of data packets includes at least one marked data packet that includes a marker indicating that the marked data packet carries data related to an objectionable video portion. The method also includes receiving a request for a burst rate from the set-top box device and transmitting the burst rate to the set-top box device, where the burst rate includes next data packets of the video content and wherein the next data packets fill the buffer.

In another embodiment, a computer program embedded in a computer-readable medium is disclosed and includes instructions to communicate with a remote control device to receive a command to edit at least one objectionable audio portion associated with video content. The computer program also includes instructions to determine whether a closed-caption component of the video content includes text related to the at least one objectionable audio portion. The computer program also includes instructions to block playback of the at least one objectionable audio portion in connection with the video content at a display device.

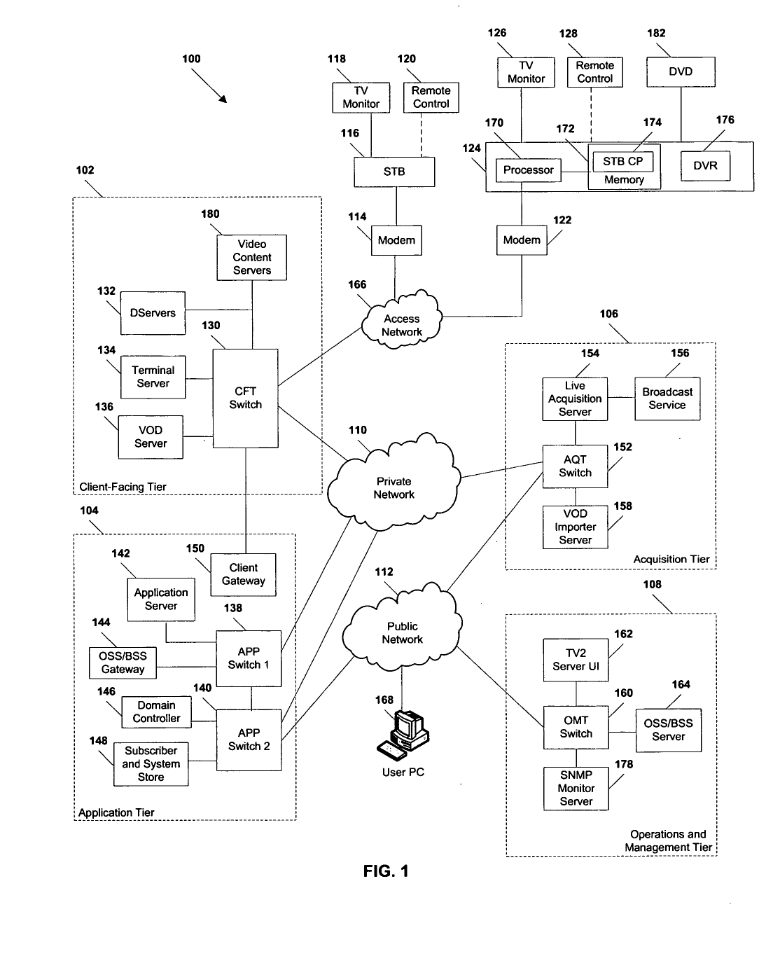

Referring to FIG. 1, an illustrative embodiment of an Internet Protocol Television (IPTV) system that may be used to provide editable video content is illustrated and is generally designated 100. As shown, the system 100 can include a client facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 can be coupled to the private network 110. Further, the application tier 104 can be coupled to the private network 110 and to the public network 112. The acquisition tier 106 can also be coupled to the private network 110 and to the public network 112. Additionally, the operations and management tier 108 can be coupled to the public network 112.

As illustrated in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104, including, but not limited to, a client gateway 150, can communicate directly with the client-facing tier 102.

As illustrated in FIG. 1, the client-facing tier 102 can communicate with user equipment via an access network 166, such as an Internet Protocol Television (IPTV) access network. In an illustrative embodiment, modems, such as a first modem 114 and a second modem 122 can be coupled to the access network 166. The client-facing tier 102 can communicate with a first representative set-top box device 116 via the first modem 114 and with a second representative set-top box device 124 via the second modem 122. The client-facing tier 102 can communicate with a large number of set-top boxes, such as the representative set-top boxes 116, 124, over a wide geographic area, such as a regional area, a metropolitan area, a viewing area, a designated market area or any other suitable geographic area, market area, or subscriber or customer group that can be supported by networking the client-facing tier 102 to numerous set-top box devices. In an illustrative embodiment, the client-facing tier 102, or any portion thereof, can be included at a video head-end office.

In a particular embodiment, the client-facing tier 102 can be coupled to the modems 114, 122 via fiber optic cables. Alternatively, the modems 114, 122 can be digital subscriber line (DSL) modems that are coupled to one or more network nodes via twisted pairs, and the client-facing tier 102 can be coupled to the network nodes via fiber-optic cables. Each set-top box device 116, 124 can process data received via the access network 166, via an IPTV software platform, such as Microsoft® TV IPTV Edition.

Additionally, the first set-top box device 116 can be coupled to a first external display device, such as a first television monitor 118, and the second set-top box device 124 can be coupled to a second external display device, such as a second television monitor 126. Moreover, the first set-top box device 116 can communicate with a first remote control 120, and the second set-top box device can communicate with a second remote control 128. The set-top box devices 116, 124 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 116, 124 can receive video content, which may include video and audio portions, from the client-facing tier 102 via the access network 166. The set-top boxes 116, 124 can transmit the video content to external display devices, such as the television monitors 118, 126. Further, the set-top box devices 116, 124 can each include a STB processor 170 and a STB memory device 172, which is accessible to the STB processor 170. In one embodiment, a computer program, such as the STB computer program 174, can be embedded within the STB memory device 172. Each set-top box device 116, 124 can also include an internal video content storage device, such as a digital video recorder 176. In a particular embodiment, the set-top box devices 116, 124 can communicate with an external video content device, such as a digital video disc (DVD) player 182.

In an illustrative embodiment, the client-facing tier 102 can include a client-facing tier (CFT) switch 130 that manages communication between the client-facing tier 102 and the access network 166, and between the client-facing tier 102 and the private network 110. As shown, the CFT switch 130 is coupled to one or more data servers, such as D-servers 132, that store, format, encode, replicate, or otherwise manipulate or prepare video content for communication from the IPTV system 100 to the set-top box devices 116, 124. The CFT switch 130 can also be coupled to a terminal server 134 that provides terminal devices with a connection point to the private network 110. In a particular embodiment, the CFT switch 130 can also be coupled to a video-on-demand (VOD) server 136 that stores or provides VOD content imported by the IPTV system 100. In a particular embodiment, the CFT switch 130 can also be coupled to one or more video content servers 180. The video content server(s) 180 can include a cluster of video content servers, such as a group of multicast video content servers.

As illustrated in FIG. 1, the application tier 104 can communicate with both the private network 110 and the public network 112. The application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. In a particular embodiment, the application server 142 can provide applications to the set-top box devices 116, 124 via the access network 166, which enable the set-top box devices 116, 124 to provide functions, such as display, messaging, processing of IPTV data and VOD material, etc. In a particular embodiment, the OSS/BSS gateway 144 includes operation systems and support (OSS) data, as well as billing systems and support (BSS) data. In one embodiment, the OSS/BSS gateway 144 can provide or restrict access to an OSS/BSS server 164 that stores operations and billing systems data.

Further, the second APP switch 140 can be coupled to a domain controller 146 that provides Internet access, for example, to users via the public network 112. For example, the domain controller 146 can provide remote Internet access to IPTV account information, e-mail, personalized Internet services, or other online services via the public network 112. Users can access such information or services using, for example, their personal computers 168. The second APP switch 140 can be coupled to a subscriber and system store 148 that includes account information, such as account information that is associated with users who access the system 100 via the private network 110 or the public network 112.

In a particular embodiment, the application tier 104 can also include a client gateway 150 that communicates data directly with the client-facing tier 102. In this embodiment, the client gateway 150 can be coupled directly to the CFT switch 130. The client gateway 150 can provide or restrict access to the private network 110 and the tiers coupled thereto.

In a particular embodiment, the set-top box devices 116, 124 can access the IPTV system 100 via the access network 166, using information received from the client gateway 150. In this embodiment, the access network 166 can provide security for the private network 110. User devices can access the client gateway 150 via the access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the access network 166.

For example, when the first representative set-top box device 116 accesses the system 100 via the access network 166, the client gateway 150 can verify subscriber information by communicating with the subscriber and system store 148 via the private network 110, the first APP switch 138, and the second APP switch 140. Further, the client gateway 150 can verify billing information and status by communicating with the OSS/BSS gateway 144 via the private network 110 and the first APP switch 138. In one embodiment, the OSS/BSS gateway 144 can transmit a query via the first APP switch 138, to the second APP switch 140, and the second APP switch 140 can communicate the query via the public network 112 to the OSS/BSS server 164. After the client gateway 150 confirms subscriber and/or billing information, the client gateway 150 can allow the set-top box device 116 to access IPTV content and VOD content. If the client gateway 150 cannot verify subscriber information for the set-top box device 116, e.g., because it is connected to an unauthorized twisted pair, the client gateway 150 can block transmissions to and from the set-top box device 116 beyond the access network 166.

As indicated in FIG. 1, the acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives or acquires television or movie content, for example, from a broadcast service 156. In a particular embodiment, the live acquisition server 154 can transmit the television or movie content to the AQT switch 152, and the AQT switch 152 can transmit the television or movie content to the CFT switch 130 via the private network 110.

Further, the television or movie content can be transmitted to the D-servers 132, where it can be encoded, formatted, stored, replicated, or otherwise manipulated and prepared for communication to the set-top box devices 116, 124. The CFT switch 130 can receive the television or movie content from the D-servers 132 and communicate the content to the modems 114, 122 via the access network 166. The set-top box devices 116, 124 can receive the television or movie content via the modems 114, 122, and can transmit the television or movie content to the television monitors 118, 126. In an illustrative embodiment, video or audio portions of the television or movie content can be streamed to the set-top box devices 116, 124.

Further, the AQT switch can be coupled to a video-on-demand importer server 158 that stores television or movie content received at the acquisition tier 106 and communicates the stored content to the VOD server 136 at the client-facing tier 102 via the private network 110. Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When users issue requests for VOD content via the set-top box devices 116, 124, the requests can be transmitted over the access network 166 to the VOD server 136, via the CFT switch 130. Upon receiving such requests, the VOD server 136 can retrieve the requested VOD content and transmit the content to the set-top box devices 116, 124 across the access network 166, via the CFT switch 130. The set-top box devices 116, 124 can transmit the VOD content to the television monitors 118, 126. In an illustrative embodiment, video or audio portions of VOD content can be streamed to the set-top box devices 116, 124.

FIG. 1 further illustrates that the operations and management tier 108 can include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to an OSS/BSS server 164 and to a simple network management protocol (SNMP) monitor server 178 that monitors network devices within or coupled to the IPTV system 100. In a particular embodiment, the OMT switch 160 can communicate with the AQT switch 152 via the public network 112.

In an illustrative embodiment, the live acquisition server 154 can transmit the television or movie content to the AQT switch 152, and the AQT switch 152, in turn, can transmit the television or movie content to the OMT switch 160 via the public network 112. In this embodiment, the OMT switch 160 can transmit the television or movie content to the TV2 server 162 for display to users accessing the user interface at the TV2 server 162. For example, a user can access the TV2 server 162 using a personal computer (PC) 168 coupled to the public network 112.

In a particular embodiment, a user can issue a request to a set-top box device, such as the second representative set-top box device 124, to receive video content, for example, from the VOD server 136 or the video content servers 180. The set-top box computer program 174 can include instructions executable by the processor 170 to transmit the request to the CFT switch 130. The set-top box device 124 can receive the video content via the modem 122, for example, and transmit the video content to a television monitor 126 that is coupled to the set-top box device 124. In another embodiment, the set-top box device 124 can receive the video content from the DVD player 182.

In a particular embodiment, the user can issue a command to the set-top box device 124 to edit the received video content. For example, the user can press a parental control editing (PCE) key or other key on the remote control device 128. The command can include a request to edit at least one objectionable audio portion, at least one objectionable video portion, or any combination thereof, from the video content. Alternatively, the set-top box 124 can edit at least one objectionable audio portion, at least one objectionable video portion, or any combination thereof, from the video content when the command is issued, according to pre-defined user preferences stored at the set-top box device 124.

In a particular embodiment, the video content received at the set-top box device 124 includes a closed-caption component. The set-top box computer program 174 can include instructions executable by the processor 170 to monitor the closed-caption component and determine whether the closed-caption component contains text related to one or more objectionable audio portions, such as curse words or sexually explicit dialogue. If the set-top box device 124 has received a request to edit objectionable audio portions, the set-top box computer program 174 can include instructions executable by the processor 170 to not include the objectionable audio portion(s) with the video content at the television monitor 126. In an illustrative embodiment, the set-top box computer program 174 can include instructions executable by the processor 170 to interrupt audio of the video content during the objectionable audio portion(s). Alternatively, the set-top box computer program 174 can include instructions executable by the processor 170 to replace the objectionable audio portion(s), for example, with pre-recorded audio of non-objectionable synonyms that are included with the video content.

In one embodiment, the processor 170 can begin monitoring the closed-caption component before it begins transmitting the video content to the television monitor 126. Thus, the processor 170 need not review the closed-caption component for the entire video content before it begins transmitting the video content to the television monitor 126. Nonetheless, the set-top box device 124 can transmit portions of the video content to the display device after determining whether a corresponding portion of the closed-caption component includes text related to objectionable audio portion(s).

Further, the set-top box computer program 174 can include instructions executable by the processor 170 to determine whether the video content contains one or more objectionable video portions, such as images of violence, sex, or nudity. If the set-top box device 124 has received a request to edit objectionable video portions from the video content, the set-top box computer program 174 can include instructions executable by the processor 170 to not include the objectionable video portion(s) with the video content at the television monitor 126. In an illustrative embodiment, the set-top box computer program 174 can include instructions executable by the processor 170 to eliminate the video portion of the video content during the objectionable audio portion(s), for example, by showing a blank screen, a black screen, a still image, a message that a scene contains adult content, or any combination thereof. Additionally, the set-top box computer program 174 can include instructions executable by the processor 170 to interrupt audio of the video content during objectionable video portion(s).

In another illustrative embodiment, the set-top box memory 172 can include a buffer that receives data packets carrying the video content from a server within the IPTV system 100, such as the VOD server 136 or video content servers 180. The data packets can include at least one marked data packet that includes a marker indicating that the marked data packet carries data related to an objectionable video portion. The set-top box computer program 174 can include instructions executable by the processor 170 to inspect data packets in the buffer and identify any marked data packets. Additionally, the set-top box computer program 174 can include instructions executable by the processor 170 to drop marked data packet(s) from the buffer and to request a burst rate of next data packets from the server that fills the buffer. Video content carried by unmarked packets is transmitted to the television monitor 126.

In one embodiment, the processor 170 can begin monitoring the data packets before it begins transmitting the video content to the television monitor 126. Alternatively, the server can transmit a number of unmarked data packets to the set-top box device 124 before any marked data packets are transmitted to the set-top box device 124. Thus, the processor 170 need not review the data packets in the entire buffer before it begins transmitting video content to the television monitor 126. The set-top box 124 can transmit the video content to the display device after determining whether any marked data packets are in the buffer, yet it can request a burst rate before the marked data packets reach a head of the buffer to prevent underflow or interruption of the video content at the television monitor 126.

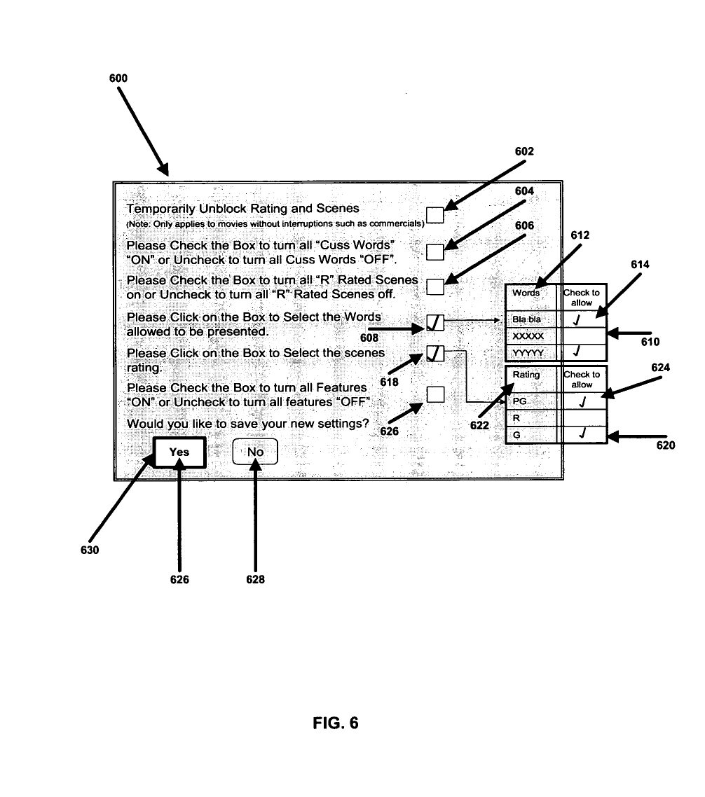

In a particular embodiment, a user of a set-top box device 116, 124 can designate objectionable material, such as objectionable audio portions, objectionable video portions, or any combination thereof, which is to be edited from video content by the set-top box device 116, 124 in response to a command to edit video content. In an illustrative embodiment, the user can issue a request to define objectionable material to the second representative set-top box device 124. The set-top box device 124 can prompt the user to input an authentication token, such as a password, pass code, or other token suitable to prevent an unauthorized party from changing designations of objectionable material. The set-top box computer program 174 can include instructions executable by the processor 170 to transmit a graphical user interface (GUI) to the television monitor 126 prompting the user to input designations of objectionable material. An example of a GUI to prompt the user for designations of objectionable material is illustrated in FIG. 6. The designations of objectionable material can be stored in the set-top box memory 172.

In another particular embodiment, the user of a set-top box device 116, 124 can designate objectionable material via a web portal maintained via a web server of the IPTV system 100, such as the domain controller 146. For example, the user can issue a request to access the web portal via the personal computer 168. The domain controller 146 can prompt the user to input an authentication token, such as a password, pass code, or other token suitable to prevent an unauthorized party from changing designations of objectionable material. If the authentication token is received, the domain controller 146 can transmit a graphical user interface (GUI) to the personal computer 168 prompting the user to input designations of objectionable material. An example of a GUI to prompt the user for designations of objectionable material is illustrated in FIG. 6. The designations of objectionable material can be transmitted from the domain controller 146 to the set-top box device 124 via the access network 166. The designations of objectionable material can be stored in the set-top box memory 172.

In an illustrative embodiment, a user can be prompted by a set-top box 116, 124 or domain controller 146 to indicate whether a designation of objectionable material is temporary or permanent and to input an expiration event when the designation is temporary. For example, a user can turn off editing of objectionable audio portions during a certain video program. The user an indicate that this change to designations of objectionable material is temporary and should only be applied until a certain time, date, day of the week, start of a video program, end of a video program, or any combination thereof. The set-top box computer program 174 can include instructions executable by the processor 170 to determine whether an expiration event has occurred and to reset designations of objectionable material to one or more previous designations, which may include one or more default designations, after the expiration event has occurred.

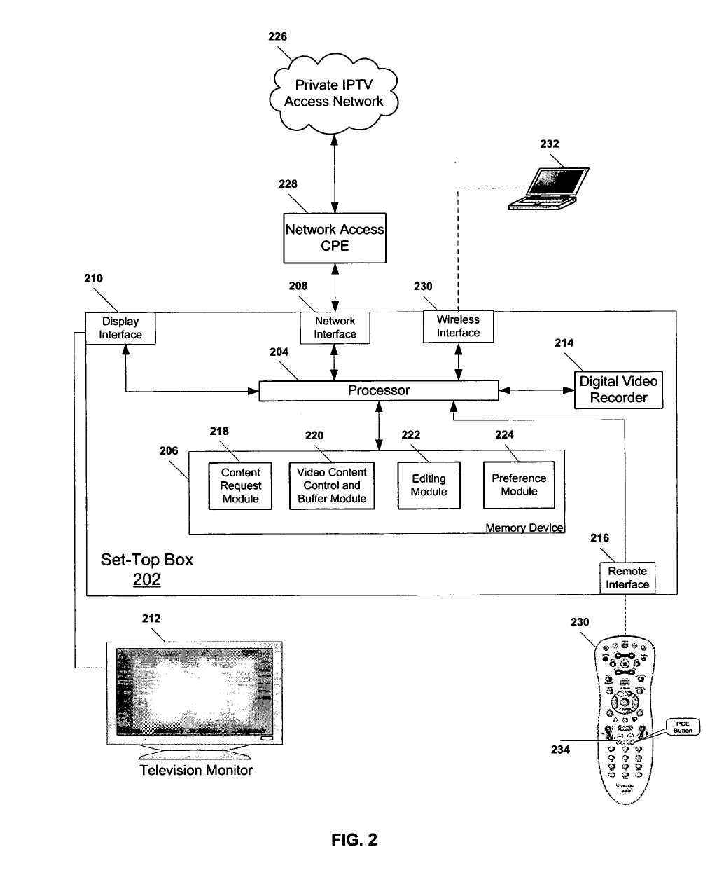

Referring to FIG. 2, an embodiment of a set-top box device configured to edit video content is illustrated and designated generally at 202. The set-top box 202 includes a processor 204 and a memory device 206 that is accessible to the processor 204. The processor 204 communicates with a network interface 208. Further, the processor 204 communicates with a display interface 210, such as a television interface, through which the set-top box device 202 can communicate video content, prompts, graphical user interfaces, or other content to an external display device, such as a television monitor 212. The processor 204 can communicate with an internal video storage device, such as a digital video recorder (DVR) 214. In addition, the processor 204 can communicate with a remote control device 230, via a remote control interface 216.

The processor 204 can communicate with an external access network, such as an Internet Protocol Television (IPTV) access network 226, via the network interface 208. In an illustrative, non-limiting embodiment, the IPTV access network 226 can be the access network 166 illustrated in FIG. 1. In a particular embodiment, network access customer premises equipment (CPE) 228 can facilitate communication between the network interface 208 and the IPTV access network 226. The network access CPE 228 can include a router, a local area network device, a modem, such as a digital subscriber line (DSL) modem, any other suitable device for facilitating communication between the network interface 208 and the IPTV access network 226, or any combination thereof. In an illustrative, non-limiting embodiment, the network access CPE 228 can be the modem 114 or 122 illustrated in FIG. 1.

In an illustrative embodiment, the processor 204 can communicate with a wireless interface 230, such as an 802.1x interface. The processor can receive and process data from, and communicate data to, a wireless computing device, such as a laptop computer 232, via the wireless interface 230. In an alternative embodiment, the set-top box device 202 can include an Ethernet connection that facilitates communication between the set-top box device 202 and the laptop computer 232.

In a particular embodiment, the memory device 206 can include a content request module 218. The content request module 218 can be executable by the processor 204 to receive a request for video content from a user, for example, via the remote control device 230. The request can be a channel change request, a video-on-demand request, a request to access video content stored at the DVR 214, or any combination thereof. The content request module 218 can be executable by the processor 204 to request the video content from a server of an IPTV system via the IPTV access network 226. In an illustrative, non-limiting embodiment, the request can be ajoin command to be added to a multicast group of a channel. In another illustrative, non-limiting embodiment, the request can include a command to download video content to the set-top box device 202.

In a particular embodiment, the memory device 206 can also include a video content control and buffer module 220 that is executable by the processor 204 to receive data packets carrying video content requested by a user and to buffer the video content before transmitting it to the display interface 210, in order to prevent underflow.

Further, the memory device 206 can include an editing module 222 that is executable by the processor 204 to communicate with the remote control device 230, for example, to receive a command to edit video content received at the set-top box device 202. In an illustrative, non-limiting embodiment, the remote control device 230 can include a parental control editing (PCE) button 234 that a user can select to issue a command to edit video content received at the set-top box device 202. In addition, the editing module 222 is executable by the processor 204 to determine whether video content received at the set-top box device 202 includes one or more objectionable audio portions, objectionable video portions, or any combination thereof, and to not include the objectionable audio portions, objectionable video portions, or any combination thereof, with the video content at the display device 212. In a particular embodiment, the editing module 222 can be executable by the processor 204 to determine whether the video content includes objectionable audio portions, objectionable video portions, or any combination thereof, based on user-defined designations stored by a preferences module 224 included in the memory device 206.

In a particular embodiment, the video content received at the set-top box device 202 can include a closed-caption component. The editing module 222 can be executable by the processor 204 to monitor the closed-caption component and determine whether the closed-caption component contains text related to one or more objectionable audio portions. The editing module 222 can be executable by the processor 204 to not include the objectionable audio portion(s) with the video content at the display device 212. In an illustrative embodiment, the editing module 222 can be executable by the processor 204 to interrupt audio of the video content during the objectionable audio portion(s). Alternatively, the editing module 222 can be executable by the processor 204 to replace the objectionable audio portion(s), for example, with audio of non-objectionable synonyms that are included with the video content.

Further, the editing module 222 can be executable by the processor 204 to determine whether the video content contains one or more objectionable video portions, such as images of violence, sex, or nudity. The editing module 222 can be executable by the processor 204 to not include the objectionable video portion(s) with the video content at the display device 212. In a particular embodiment, the editing module 222 can be executable by the processor 204 to eliminate the video portion of the video content during the objectionable audio portion(s), for example, by showing a blank screen, a black screen, a still image, a message that a scene contains adult content, or any combination thereof. Additionally, the editing module 222 can be executable by the processor 204 to interrupt audio of the video content during the objectionable video portion(s).

In an illustrative embodiment, the video content control and buffer module 220 can receive data packets carrying requested video content from a server via the private IPTV access network 226. The data packets can include at least one marked data packet that includes a marker indicating that the marked data packet carries data related to an objectionable video portion. The editing module 222 can be executable by the processor 204 to inspect the data packets in a buffer of the video content control and buffer module 220 and to identify any marked data packets. Additionally, the editing module 222 can be executable by the processor 204 to drop the marked data packet(s) and to request a burst rate of next data packets from the server that fills the buffer of the video content control and buffer module 220. Alternatively, the editing module 222 can be executable by the processor 204 to instruct the content request module 218 to request the burst rate.

In a particular embodiment, the editing module 222 can be executable by the processor 204 to communicate with the remote control device 230, for example, to receive a second command to not edit video content received at the set-top box device 202. The editing module 222 can be executable by the processor 204 to transmit a prompt for an authentication token in response to the second command. In addition, the editing module 222 can be executable by the processor 204 to not edit video content received at the set-top box device after the authentication token is received.

In a particular embodiment, the preferences module 224 can be executable by the processor 204 to transmit a prompt to receive an authentication token in response to a request received from a user to define objectionable material. In addition, the preferences module 224 can be executable by the processor 204 to transmit a prompt to the display device 212 to receive designations of objectionable audio portions, objectionable video portions, or any combination thereof, when the authentication token is received. In an illustrative embodiment, the preferences module 224 can be executable by the processor 204 to transmit a graphical user interface (GUI), such as that illustrated in FIG. 6, to the television monitor 212 and to receive user-defined designations of objectionable material, such as objectionable audio portions, objectionable video portions, or any combination thereof, via the GUI.

In another particular embodiment, the preferences module 224 can be executable by the processor 204 to communicate with the private IPTV access network 226, to receive designations of objectionable audio portions, objectionable video portions, or any combination thereof, from a web server of an IPTV system, where the web server has received the designations from a user computing device via a web portal.

In another particular embodiment, the preferences module 224 can be executable by the processor 204 to communicate with the laptop computer 232 via the wireless interface 230 to receive designations of objectionable audio portions, objectionable video portions, or any combination thereof, from a web server of an IPTV system, where the web server has received the designations from a user via a web portal. For example, the preferences module 224 can be executable by the processor 204 to transmit a graphical user interface (GUI) to the laptop computer 232 and to receive user-defined designations of objectionable material via the GUI.

In an illustrative embodiment, the preferences module 224 can be executable by the processor 204 to determine whether designations of objectionable audio portions, objectionable video portions, or any combination thereof, include a temporary or permanent status. Further, the preferences module 224 can be executable by the processor 204 to reset temporary designations of objectionable audio portions, objectionable video portions, or any combination thereof, to previous designations, which may include default designations.

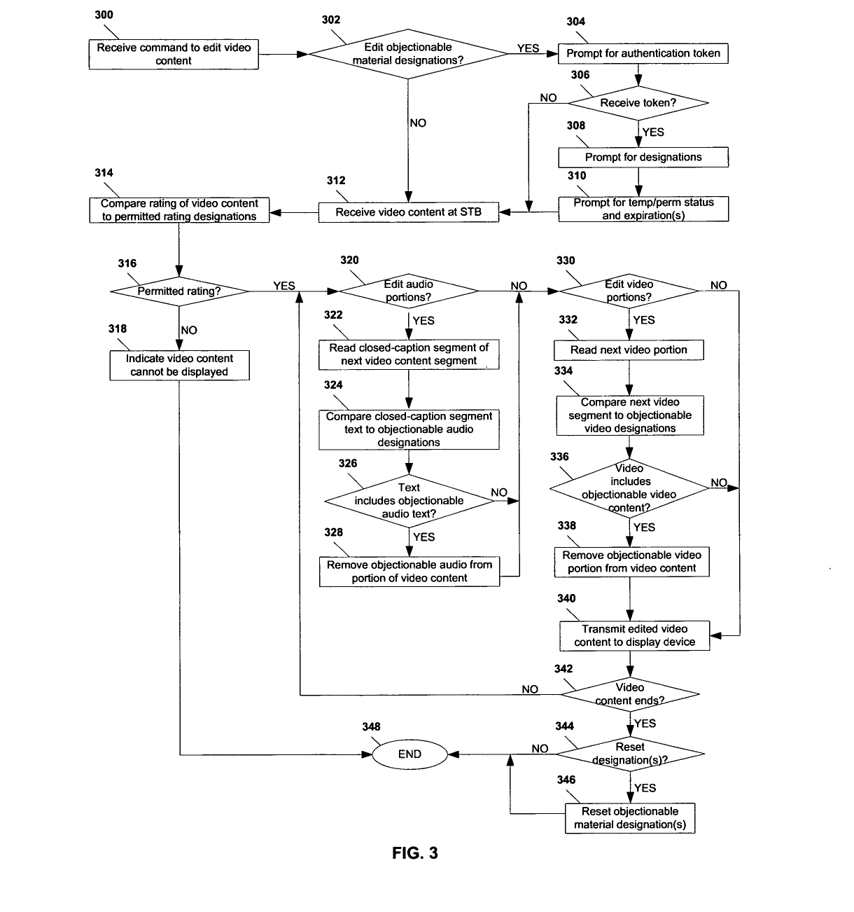

Referring to FIG. 3, a particular embodiment of a method of editing video content is illustrated. At block 300, a set-top box device receives a command to edit video content from a user. In an illustrative embodiment, the set-top box device can receive the command from a remote control device that communicates with the set-top box device. The command can include a request to remove one or more objectionable audio portions, one or more objectionable video portions, or any combination thereof, from video content received at the set-top box device. Alternatively, the set-top box device can remove one or more objectionable audio portions, one or more objectionable video portions, or any combination thereof, in response to the command, based on user-defined preferences stored at the set-top box device.

Moving to block 302, in a particular embodiment, the set-top box can determine whether the user wishes to edit designations of objectionable material, which can include objectionable audio portions, objectionable video portions, objectionable program ratings, or any combination thereof. For example, the set-top box device can send a prompt to a display device coupled to the set-top box device asking the user whether designations of objectionable material are to be edited. If the set-top box device determines that designations of objectionable material are not to be edited, the method proceeds to block 312. On the other hand, if the set-top box device determines that designations of objectionable material are to be edited, the method continues to block 304, and the set-top box device can prompt the user to input an authentication token.

Advancing to decision step 306, the set-top box determines whether it has received the authentication token. If the set-top box device has not received the authentication token, the method moves to block 312. Conversely, if the set-top box device receives the authentication token, the method moves to block 308, and the set-top box device prompts the user to input designations of objectionable material. In an illustrative embodiment, at block 310, the set-top box device can also prompt the user to indicate a temporary or permanent status related to each of the designations and an expiration event related to one or more of the temporary designations. The method then proceeds to block 312.

At block 312, the set-top box receives requested video content. In a particular embodiment, the set-top box device can receive the requested video content from a server of an Internet Protocol Television (IPTV) network via an access network. In another embodiment, the set-top box device can receive the requested video content from a digital video disc (DVD) player or video cassette recorder (VCR) coupled to the set-top box device. In another embodiment, the video content can be stored in a digital video recorder (DVR) within the set-top box device.

Continuing to block 314, in an illustrative embodiment, the set-top box can compare a rating of the video content to rating designations permitted by user preferences stored at the set-top box device. At decision step 316, the set-top box device determines whether the rating of the video content is a permitted rating. If the rating of the video content is not permitted, the method proceeds to block 318, and the set-top box can transmit a message to the display device indicating that the video content cannot be displayed. The method then terminates at 348. Conversely, if the set-top box device determines that the rating of the video content is a permitted rating, the method moves to decision step 320.

At decision step 320, the set-top box determines whether the command to edit the video content includes a request to remove objectionable audio portions from the video content. In another embodiment, the set-top box device can determine whether user-preferences stored at the set-top box device indicate that the set-top box device is to remove objectionable audio portions in response to the command received at block 300 to edit the video content. If the set-top box determines that it is not to remove objectionable audio portions from the video content, the method moves to decision step 330. Conversely, if the set-top box determines that it is to remove objectionable audio portions from the video content, the method continues to block 322.

At block 322, the set-top box device reads a segment of a closed-caption component of the requested video content that corresponds to a next segment of the requested video content, such as a next scene, a next number of lines of dialogue, a next time period, a next amount of video content in a buffer of the set-top box device, or any combination thereof. Proceeding to block 324, the set-top box device compares text in the segment of closed-captioning to designations of objectionable audio portions stored at the set-top box device. At decision step 326, the set-top box device determines whether the segment of closed-captioning includes text related to objectionable audio portions. If the segment does not include one or more objectionable audio portions, the method moves to decision step 330. Whereas, if the segment includes one or more objectionable audio portions, the set-top box device removes the objectionable audio portion(s) from the video content. The method then proceeds to decision step 330.

Moving to decision step 330, the set-top box device determines whether the command to edit the video content includes a request to remove objectionable video portions from the video content. In another embodiment, the set-top box device can determine whether user-preferences stored at the set-top box device indicate that the set-top box device is to remove objectionable video portions in response to the command received at 300 to edit the video content. If the set-top box determines that it is not to remove objectionable video portions from the video content, the method advances to block 340, and the set-top box device transmits the edited video content to the display device. Conversely, if the set-top box determines that it is to remove objectionable video portions from the video content, the method continues to block 332.

At block 332, the set-top box device reads a next video segment of the requested video content, such as a next scene, a next number of lines of dialogue, a next time period, a next amount of video content in a buffer of the set-top box device, or any combination thereof. Proceeding to block 334, the set-top box device compares video in the video segment to designations of objectionable video portions stored at the set-top box device. At decision step 336, the set-top box device determines whether the video segment includes objectionable video portions. If the segment does not include one or more objectionable video portions, the method moves to block 340. Whereas, if the segment includes one or more objectionable audio portions, the method proceeds to block 338, and the set-top box device removes the objectionable video portion(s) from the video content. The method proceeds to block 340, and the edited video content is transmitted to the display device.

Moving to decision step 342, the set-top box device can determine whether the video content ends after the edited video content is transmitted to the display device. If the set-top box device determines that the video content does not end, the method can return to decision step 320. Conversely, if set-top box device determines that the video content ends, the method can continue to decision step 344. At decision step 344, in a particular embodiment, the set-top box device determines whether to reset any designations of objectionable material. For example, the set-top box device can determine whether an expiration event has occurred for any temporary designations of objectionable material. If the set-top box device determines that no designation(s) are to be reset, the method terminates at 348. If the set-top box device determines that one or more designations are to be reset, the method proceeds to block 346, and the set-top box device resets the designations. The method terminates at 348.

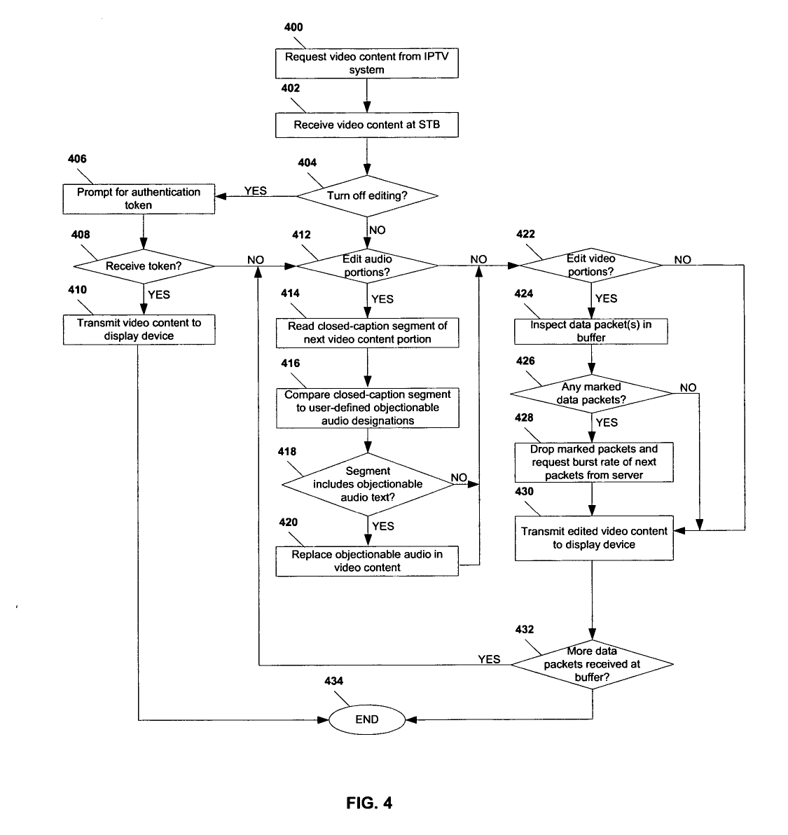

Referring to FIG. 4, a second particular embodiment of a method of editing video content is illustrated. At block 400, a set-top box device requests video content from a server of an Internet Protocol Television (IPTV) system. Moving to block 402, the set-top box receives the requested video content. In an illustrative embodiment, the video content can be carried by a plurality of data packets that are received into a buffer of the set-top box device.

In a particular embodiment, the set-top box device can be configured to remove one or more objectionable audio portions, one or more objectionable video portions, or any combination thereof, from the video content, for example, based on user-defined preferences stored at the set-top box device. Continuing to decision step 404, in an illustrative embodiment, the set-top box can determine if it has received a command to turn off editing of video content. For instance, the set-top box device can receive the command from a remote control device. If the set-top box device has received a command to turn off editing of video content, the method proceeds to block 406, and the set-top box can transmit a prompt for the user to input an authentication token to the display device. At decision step 408, the set-top box device can determine whether it has received the authentication token. If the set-top box device has not received the authentication token, the method proceeds to decision step 412. On the other hand, if the set-top box device has received the authentication token, the method proceeds to block 410, and the video content is transmitted to a display device coupled to the set-top box device. The method then terminates at 434.

Moving to decision step 412, the set-top box determines whether it is to remove objectionable audio portions from the video content. If the set-top box determines that it is not to remove objectionable audio portions from the video content, the method moves to decision step 422. Conversely, if the set-top box determines that it is to remove objectionable audio portions from the video content, the method continues to block 414. At block 414, the set-top box device reads a segment of a closed-caption component of the requested video content that corresponds to a next segment of the requested video content, such as a next scene, a next number of lines of dialogue, a next time period, a next amount of video content in a buffer of the set-top box device, or any combination thereof.

Proceeding to block 416, the set-top box device compares text in the segment of closed-captioning to designations of objectionable audio portions stored at the set-top box device. At decision step 418, the set-top box device determines whether the segment of closed-captioning includes text related to objectionable audio portions. If the segment does not include text related to one or more objectionable audio portions, the method moves to decision step 422. Whereas, if the segment includes text related to one or more objectionable audio portions, the method advances to block 420, and the set-top box device replaces the objectionable audio portion(s) within the video content. For example, data packets carrying the video content can include data related to synonyms or other replacement words post-recorded by an actor speaking the objectionable audio portions, and the set-top box device can insert these replacement words into the video content. The method then proceeds to decision step 422.

Moving to decision step 422, the set-top box device determines whether it is to remove objectionable video portions from the video content. If the set-top box determines that it is not to remove objectionable video portions from the video content, the method advances to block 430, and the video content edited to remove objectionable audio portions is transmitted to the display device. Conversely, if the set-top box determines that it is to remove objectionable video portions from the video content, the method continues to block 424. At block 424, the set-top box device inspects data packets received into the buffer of the set-top box device. Continuing to decision step 426, the set-top box determines whether the data packets include one or more marked data packets, each having a marker indicating that the data packet carries video content containing objectionable video portions. If the set-top box device determines that there are no marked packets in the buffer, the method proceeds to block 430. Whereas, if the set-top box device determines that there are marked packets in the buffer, the method continues to block 428. At block 428, the set-top box device drops the marked packets and requests a burst rate of data packets from the server that fill the buffer. The method then proceeds to block 430, and the edited video content, which may include unmarked packets with or without editing of objectionable audio portions, is transmitted to the display device.

Moving to decision step 432, the set-top box device can determine whether more data packets have been received into the buffer. If the set-top box device determines that more data packets have been received in to the buffer, the method can return to decision step 420. Conversely, if set-top box device determines that no more data packets have been received in to the buffer, the method terminates at 434.

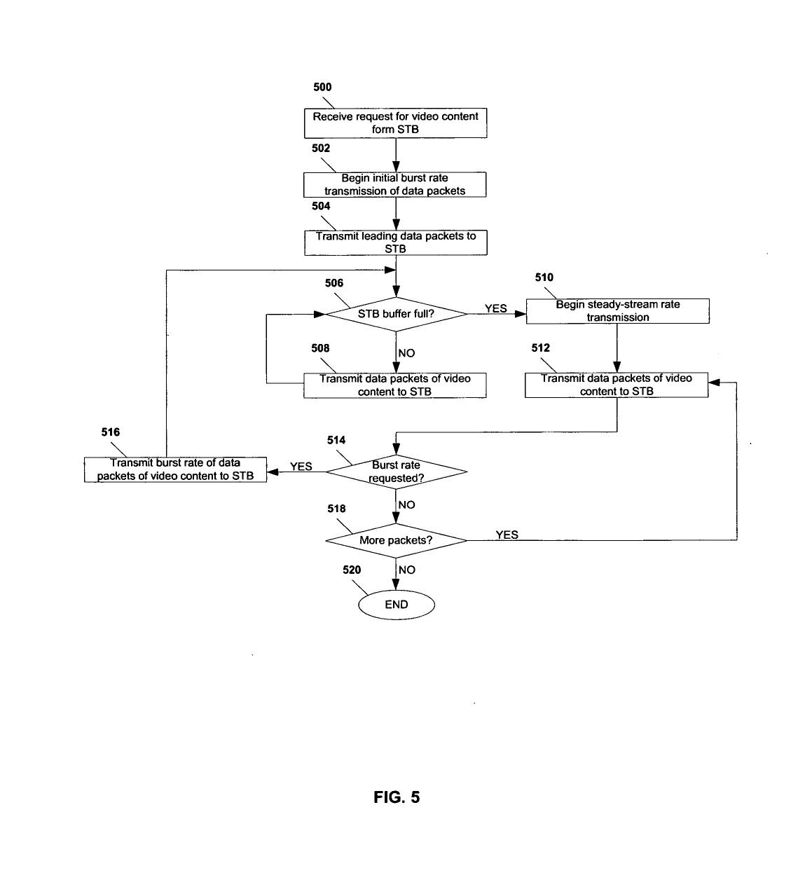

Referring to FIG. 5, an illustrative embodiment of a method of providing video content is illustrated. At block 500, a server within an Internet Protocol Television (IPTV) system receives a request from a set-top box device via an access network to receive video content. Moving to block 502, the server can begin an initial burst rate transmission of data packets to the set-top box device, such that a buffer at the set-top box device is filled. The data packets can carry data related to the requested video content. Continuing to block 504, in a particular embodiment, the server can transmit a plurality of leading data packets that do not contain objectionable material, such as packets that carry data corresponding to a black screen, blank screen, still image, opening credits of a video program, copyright warnings of a video program, production company logos, IPTV service provider logos, other graphical or textual representations, or any combination thereof.

Proceeding to decision step 506, the server can determine whether the set-top box device buffer is filled, for example, by receiving an acknowledgement or command from the set-top box device. If the server determines that the set-top box device buffer is not filled, the method advances to block 508, and the server can continue its burst rate transmission with data packets carrying the requested video content. The method then returns to decision step 506. Once the server determines that the set-top box device buffer is filled, the method proceeds to block 510, and the server can begin a steady-stream rate of transmission of data packets to the set-top box device. The method continues to block 512, and the server transmits data packets carrying the requested video content to the set-top box device.

Moving to block 514, the server determines whether a request to receive a burst rate of next data packets carrying video content is requested by the set-top box device. If the server determines that a request to receive a burst rate of next data packets is received, the method proceeds to block 516, and the server transmits a burst rate of next data packets to the set-top box device. In an illustrative embodiment, a request for a burst rate can be received from the set-top box device when the set-top box device drops packets that carry data related to one or more objectionable video portions. The method then returns to decision step 506, and the server continues the burst rate until the set-top box buffer is full. On the other hand, if the server determines that a request to receive a burst rate of next data packets has not been received, the method continues to decision step 518, and the server determines whether more there are more data packets carrying the requested video content to send to the set-top box device. If the server determines that there are more data packets, the method returns to block 512. Whereas, if the server determines that there are no more data packets, the method terminates at 520.

Though the aspects of the disclosed methods have been presented in a certain order, for ease of description, certain portions of the methods may be performed in a different order or simultaneously. For example, determinations of whether a set-top box device is to edit objectionable video portions may proceed or occur simultaneously with determinations of whether a set-top box device is to edit objectionable audio portions.

Referring to FIG. 6, a particular embodiment of a graphical user interface (GUI) to edit video content is illustrated and designated generally at 600. The GUI 600 can include a series of check-boxes or other selectable indicator to allow a user to indicate selections. In an illustrative embodiment, the GUI 600 can include a first selectable indicator 602 that a user may choose to temporarily activate or deactivate editing of video content. Upon selecting the first selectable indicator 602, the user may be prompted to enter an expiration event after which editing of video content will resume.

Further, the GUI 600 can include a second selectable indicator 604 that a user may choose to activate or deactivate editing of objectionable audio portions. In addition, the GUI 600 can include a third selectable indicator 606 that a user may choose to activate or deactivate editing of objectionable video portions. Moreover, the GUI 600 can include a fourth selectable indicator 608 that a user may choose to customize editing of objectionable audio portions. If the user selects the fourth selectable indicator 608, an objectionable audio table 610 can be displayed. The objectionable audio table can include a list of words 612 given by the GUI 600, words that a user inputs to the objectionable audio table, or any combination thereof. The user can select allowance or editing of each word in the list 612, for example, by placing a check in a second column 614.

The GUI 600 can include a fifth selectable indicator 618 that a user may choose to customize editing of objectionable video portions. If the user selects the fifth selectable indicator 618, an objectionable video table 620 can be displayed. The objectionable video table can include a list of scene ratings 622 given by the GUI 600, ratings that a user inputs to the objectionable audio table, or any combination thereof. The user can select allowance or editing of scenes having each rating in the list 622, for example, by placing a check in another column 624 of the objectionable video table 620.

In a particular embodiment, the GUI 600 can include additional selectable indicators 626-628 that a user may choose to save or not save any changes to the user's preferences or designations of objectionable audio portions, objectionable video portions, or any combination thereof. In an exemplary embodiment, a user can make selections within the GUI 600 by using arrow keys on a remote control and by pressing an ‘OK,’ ‘ENTER,’ ‘SELECT,’ or similar key when a desired indicator is highlighted by a highlight bar 630.

In conjunction with the configuration of structure described herein, the system and method disclosed allow a user of a set-top box device to edit objectionable audio portions, objectionable video portions, or any combination thereof, from video content received at a set-top box device. In a particular embodiment, objectionable audio portions are removed by monitoring a closed-caption component of the video content in advance of what is displayed on a display device coupled to the set-top box device and by identifying text related to the objectionable audio portions. In an illustrative embodiment, the user can seamlessly remove objectionable video portions from video content by dropping marked data packets carrying the objectionable video portions and receiving a burst rate of next data packets of the video content that fill up a buffer of the set-top box device.

In a particular embodiment, the system and method allow the user of a set-top box device to designate objectionable audio portions, objectionable video portions, or any combination thereof, in user-defined preferences that are stored at the set-top box device. The designations can be entered at the set-top box device, via a graphical user interface (GUI) or other prompt that the set-top box transmits to the display device. In another embodiment, the designations can be entered via a web portal maintained by a web server of an Internet Protocol Television (IPTV) system, and the designations can be transmitted to a set-top box device associated with the user. Thus, the user need not be at the same location as the set-top box to change preferences. Additionally, the user can make temporary designations with respect to objectionable audio portions, objectionable video portions, or any combination thereof and set an expiration event after which the designations will be reset to previous designations, which may include default designations.

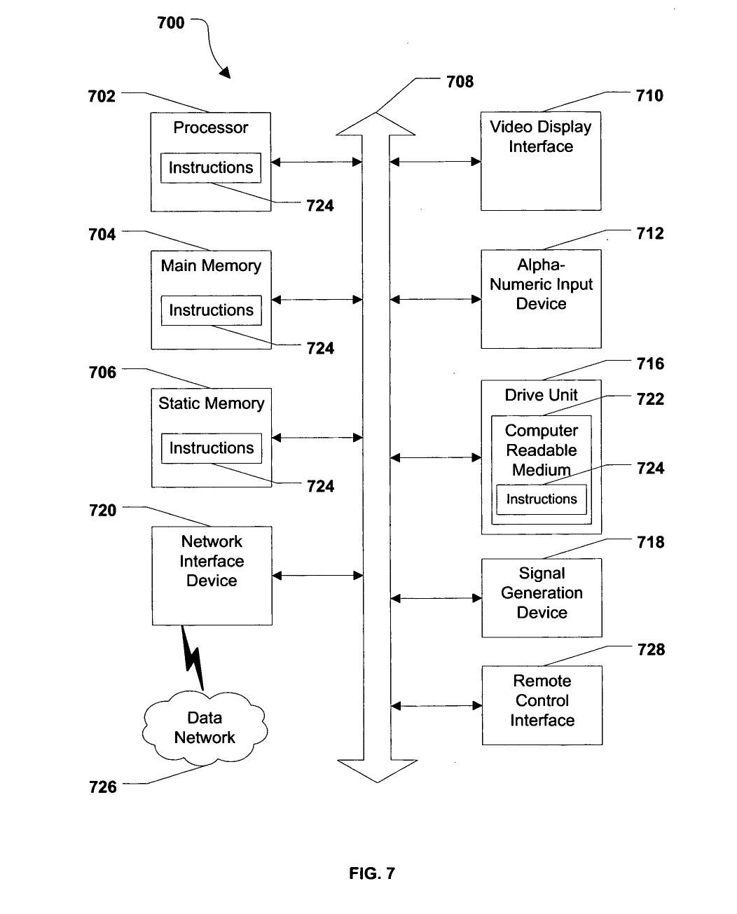

Referring to FIG. 7, an illustrative embodiment of a general computer system is shown and is designated 700. The computer system 700 can include a set of instructions that can be executed to cause the computer system 700, or a portion thereof, to perform any one or more of the methods or computer based functions disclosed herein. The computer system 700, or any portion thereof, may operate as a standalone device or may be a hardware or software module within a server or other device, as illustrated in FIG. 1.

The computer system 700 can also be implemented as or incorporated into various other devices, such as the set-top box devices illustrated in FIGS. 1-2, or any other machine capable of executing a set of instructions (sequential or otherwise) that specify actions to be taken by that machine. In a particular embodiment, the computer system 700 can be implemented using electronic devices that provide audio, video or data communication. Further, while a single computer system 700 is illustrated, the term “system” shall also be taken to include any collection of systems or sub-systems that individually orjointly execute a set, or multiple sets, of instructions to perform one or more computer functions.

As illustrated in FIG. 7, the computer system 700 may include a processor 702, e.g., a central processing unit (CPU), a graphics-processing unit (GPU), or both. Moreover, the computer system 700 can include a main memory 704 and a static memory 706 that can communicate with each other via a bus 708. As shown, the computer system 700 may further include a video display unit 710, such as a liquid crystal display (LCD), an organic light emitting diode (OLED), a flat panel display, a solid state display, or a cathode ray tube (CRT). Additionally, the computer system 700 may include an input device 712, such as a remote control input, an input control panel, a keyboard, a mouse, a gaming station input, or one or more keys disposed on a set-top box device. The computer system 700 can also include a disk drive unit 716, or other secondary storage interface configured to receive a removable secondary storage medium. The computer can also include a signal generation device 718, and a network interface device 720.

In a particular embodiment, as depicted in FIG. 7, the disk drive unit 716 may include a computer-readable medium 722 in which one or more sets of instructions 724, e.g. software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives instructions 724 responsive to a propagated signal, so that a device connected to a network 726 can communicate audio, video or data over the network 726. Further, the instructions 724 may be transmitted or received over the network 726 via the network interface device 720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of editing video content, the method comprising:
receiving a command at a set-top box device, wherein the command includes a request to edit at least one objectionable audio portion associated with video content;
receiving the video content at the set-top box device, wherein the video content includes a closed-caption component; and
determining whether the closed-caption component of the video content includes text related to the at least one objectionable audio portion.

2. The method of claim 1, wherein the at least one objectionable audio portion is not removed prior to display of the video content at a display device coupled to the set-top box device.

3. The method of claim 1, further comprising receiving the command from a remote control device.

4. The method of claim 1, further comprising transmitting a portion of the video content to the display device after determining whether a corresponding portion of the closed-caption component includes text related to the at least one objectionable audio portion.

5. The method of claim 1, further comprising:
receiving a request to define a plurality of objectionable audio portions;
prompting to obtain designations of the plurality of objectionable audio portions; and
storing the designations of the plurality of objectionable audio portions at the set-top box device.

6. The method of claim 5, further comprising prompting to receive an authentication token before storing the designations of the plurality of objectionable audio portions.

7. The method of claim 1, further comprising:
receiving a second command at the set-top box device to block editing of video content;
prompting to receive an authentication token; and
blocking editing of video content received at the set-top box device after the authentication token is received.

8. The method of claim 1, wherein the command includes a request to edit at least one objectionable video portion from the video content.

9. The method of claim 8, further comprising:
receiving data packets of the video content from a server of an Internet Protocol Television (IPTV) system at the set-top box device via an access network;
identifying at least one marked data packet, wherein the at least one marked data packet includes a marker indicating that the marked data packet carries data related to the at least one objectionable video portion; and
dropping the at least one marked data packet.

10. The method of claim 9, wherein the data packets are stored in a buffer of the set-top box device.

11. The method of claim 10, further comprising requesting a burst rate from the server, wherein the burst rate includes next data packets of the video content and wherein the next data packets fill the buffer.

12. The method of claim 9, further comprising receiving designations of the at least one objectionable audio portion and the at least one objectionable video portion at the set-top box device via the access network, wherein the designations of the objectionable audio portions are received at a web server of the IPTV system.

13. A method of editing video content, the method comprising:
receiving a request for video content from a set-top box device at a server of an Internet Protocol Television (IPTV) system;
transmitting a plurality of data packets of the video content to the set-top box device, wherein the plurality of data packets are received at a buffer of the set-top box device and wherein the plurality of data packets includes at least one marked data packet that includes a marker indicating that the marked data packet carries data related to an objectionable video portion;
receiving a request for a burst rate from the set-top box device; and
transmitting the burst rate to the set-top box device, wherein the burst rate includes next data packets of the video content and wherein the next data packets fill the buffer after the set-top box device drops the at least one marked data packet.

14. The method of claim 13, further comprising transmitting at least one unmarked data packet to the set-top box device before transmitting the at least one marked data packet to the set-top box device.

15. The method of claim 14, wherein the set-top box device requests the burst rate before the at least one marked data packet reaches a head of the buffer.

16. A set-top box, comprising:
a processor;
a memory device accessible to the processor;
wherein the memory device includes an editing module executable by the processor to determine whether a closed-caption component of video content includes text related to at least one objectionable audio portion; and
wherein the editing module is executable by the processor to not include the at least one objectionable audio portion in connection with the video content at a display device coupled to the set-top box device.

17. The set-top box of claim 16, wherein the editing module is executable by the processor to transmit a black screen, a blank screen, a still image, a message, or any combination thereof, to the display device during an objectionable video portion of the video content.

18. The set-top box of claim 17, wherein the editing module is executable by the processor to interrupt audio of the video content during the objectionable video portion.

19. The set-top box of claim 18, wherein the editing module is executable by the processor to not include the at least one objectionable audio portion, the at least one objectionable video portion, or any combination thereof, with the video content in response to a selection of a parental control editing (PCE) button of a remote control device.

20. The set-top box device of claim 16, further comprising:
a buffer portion that receives data packets of the video content from a server of an Internet Protocol Television (IPTV) system via an access network;
wherein the editing module is executable by the processor to identify at least one marked data packet, wherein the at least one marked data packet includes a marker indicating that the marked data packet carries data related to an objectionable video portion; and
the editing module is executable by the processor to drop the at least one marked data packet from the buffer.

21. The method of claim 20, wherein the editing module is executable by the processor to request a burst rate from the server.

22. The set-top box device of claim 16, further comprising a preferences module executable by the processor to store user-defined designations of objectionable audio portions, objectionable video portions, or any combination thereof.

23. The set-top box device of claim 22, wherein:
the preferences module is executable by the processor to transmit a graphical user interface (GUI) to the display device; and
wherein a user defines the designations of objectionable audio portions, objectionable video portions, or any combination thereof, via the GUI.

24. The set-top box device of claim 22, wherein:
the designations of objectionable audio portions, objectionable video portions, or any combination thereof, are received at a web server of an Internet Protocol Television (IPTV) system; and
the designations are received at the set-top box via an access network of the IPTV system.

25. The set-top box device of claim 22, wherein:
the preferences module is executable by the processor to transmit a graphical user interface (GUI) to a user computing device via a wireless interface of the set-top box device; and
wherein a user defines the designations of objectionable audio portions, objectionable video portions, or any combination thereof, via the GUI.

26. The set-top box device of claim 22, wherein:
the preferences module is executable by the processor to transmit a graphical user interface (GUI) to a user computing device via an Ethernet connection of the set-top box device; and
wherein a user defines the designations of objectionable audio portions, objectionable video portions, or any combination thereof, via the GUI

27. A computer program embedded in a computer-readable medium, the computer program comprising:
instructions to communicate with a remote control device to receive a command to edit at least one objectionable audio portion associated with video content;
instructions to determine whether a closed-caption component of the video content includes text related to the at least one objectionable audio portion; and
instructions to block playback of the at least one objectionable audio portion in connection with the video content at a display device.

28. The computer program of claim 27, further comprising instructions to replace the at least one objectionable audio portion with a replacement audio portion and to include the replacement audio portion with the video content at the display device.

29. The computer program of claim 27, further comprising:
instructions to communicate with a server of an Internet Protocol Television (IPTV) system to receive data packets of the video content at a buffer;
instructions to identify at least one marked data packet, wherein the at least one marked data packet includes a marker indicating that the marked data packet carries data related to an objectionable video portion;
instructions to drop the at least one marked data packet; and
instructions to request a burst rate from the server, wherein the burst rate includes next data packets of the video content and wherein the next data packets fill the buffer.

30. The computer program of claim 27, further comprising instructions to store at least one user-defined designation of an objectionable audio portion, an objectionable video portion, or any combination thereof.

31. The computer program of claim 30, further comprising:
instructions to prompt a user to obtain a status of the at least one user-defined designation; and
instructions to prompt the user to obtain an expiration event when the status is a temporary status.

32. The computer program of claim 31, further comprising:
instructions to determine whether the expiration event has occurred; and
instructions to reset the at least one user-defined designation to a previous designation of an objectionable audio portion, an objectionable video portion, or any combination thereof, after the expiration event has occurred.

33. The computer program of claim 31, wherein the expiration event is a time, a date, a day of a week, an end of a video program, a start of a video program, or any combination thereof.
